(19) United States
(12) Patent Application Publication
(10) Pub. No.: US 2011/0150193 A1
(43) Pub. Date: Jun. 23, 2011

(54) SYSTEM AND METHOD FOR MONETIZING TELEPHONE CALLS TO DISCONNECTED BUSINESS LISTINGS

(76) Inventors: Nelson Cain, McKinney, TX (US); Rick Kodweis, Pittsford, NY (US); Christine Whites, Pittsford, NY (US)

(21) Appl. No.: 12/968,539

(22) Filed: Dec. 15, 2010

Related U.S. Application Data
(60) Provisional application No. 61/289,765, filed on Dec. 23, 2009.

(51) Int. Cl. H04M 1/64

(52) U.S. Cl. 379/88.22

(57) ABSTRACT

A method includes developing a call profile for a call that has been identified for intercept treatment, the call comprising a call from a caller to a disconnected listing. The developing comprises accessing one or more listing characteristics for the disconnected listing independently of the caller. The method further includes selecting a targeted advertisement for the caller based at least in part on the call profile. Additionally, the method includes reporting to the caller regarding the disconnected listing, the reporting comprising presenting the targeted advertisement to the caller.

### CROSS-REFERENCE TO RELATED APPLICATIONS

This Application claims priority from, and incorporates by reference the entire disclosure of, U.S. Provisional Application 61/289,765 filed on Dec. 23, 2009.

### BACKGROUND

1. Technical Field

This invention relates generally to systems and methods for handling telephone calls and more particularly, but not by way of limitation, to a system and method for monetizing telephone calls to disconnected listings.

2. History of Related Art

Traditional intercept telephony systems play an intercept message to a caller when a call to an individual or business cannot be completed. A call might not be able to be completed for any of a number of reasons such as, for example, local congestion, disconnection of a dialed phone, or network trouble. The intercept message played to the caller is traditionally limited to reporting an inability to complete the call. For example, the intercept message played to the caller may be “the number you dialed has been disconnected (or changed).”

The intercept message is generally of no practical utility to the caller. After hearing the intercept message, the caller is typically left to his or her own ingenuity to find, for example, another business that provides desired goods or services. In an attempt to identify alternatives, the caller may utilize directory assistance, search the Internet, or rely on other resources. In many cases, the caller may abandon the pursuit entirely.

### SUMMARY OF THE INVENTION

In one embodiment, a method includes developing a call profile for a call that has been identified for intercept treatment, the call comprising a call from a caller to a disconnected listing. The developing comprises accessing one or more listing characteristics for the disconnected listing independently of the caller. The method further includes selecting a targeted advertisement for the caller based at least in part on the call profile. Additionally, the method includes reporting to the caller regarding the disconnected listing, the reporting comprising presenting the targeted advertisement to the caller.

In one embodiment, a system includes a network switch in communication with a calling terminal, an intercept service having access to one or more intercept service databases, a voice feature node in communication with the network switch and the intercept service, and a call-distributor service module operable to manage voice connectivity between the voice feature node and the network switch. The voice feature node is operable to develop a call profile for a call that has been identified for intercept treatment via the network switch, the call comprising a call from a caller to a disconnected listing. The development of a call profile includes accessing one or more listing characteristics for the disconnected listing via the intercept service. The voice feature node is further operable to select a targeted advertisement for the caller based at least in part on the call profile. In addition, the voice feature node is operable to report to the caller regarding the disconnected listing, the reporting comprising presenting the targeted advertisement to the caller; and

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a diagram of a telephony system; and

FIG. 2 is a call-flow diagram that illustrates a call traversing through a telephony system.

### DETAILED DESCRIPTION OF ILLUSTRATIVE EMBODIMENTS OF THE INVENTION

In various embodiments, an intercept telephony system may include both automated and agent-assisted service capabilities for handling calls that cannot be completed. For example, the intercept telephony system may be operable to handle a call dialed to a business to which telephone service has been disconnected. In various embodiments, the intercept telephony system may be operable to present a targeted advertisement to a caller based at least in part on a call profile. The call profile may include, for example, caller characteristics for an incoming call and listing characteristics for a business to which telephone service has been disconnected. As a result, in various embodiments, the intercept telephony system is operable to provide more useful information to the caller and provide revenue-generating opportunities to telecommunications carriers that provide intercept service using the intercept telephony system.

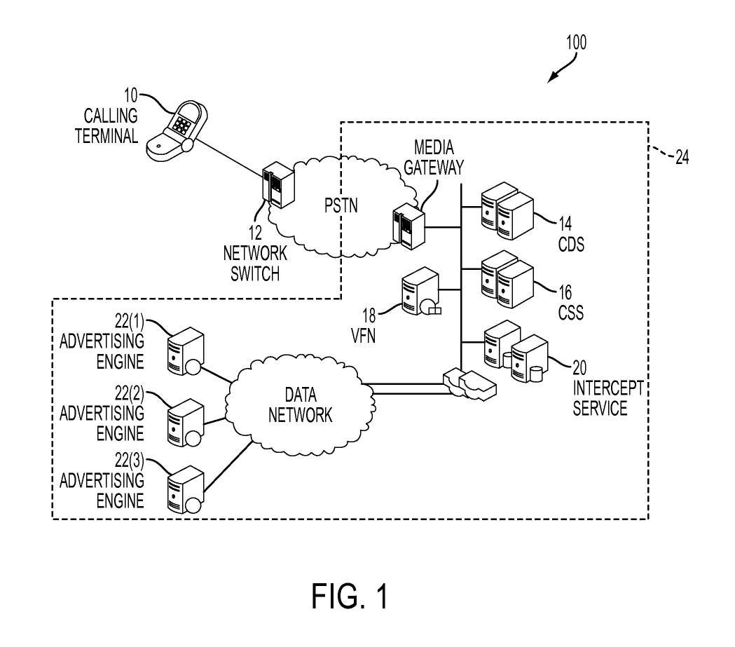

FIG. 1 depicts a telephony system 100. The telephony system 100 includes a calling terminal 10, a network switch 12, a call-distributor service module 14, a call-screening service module 16, a voice feature node (“VFN”) 18, an intercept service 20 having access to a plurality of intercept service databases, and a plurality of advertising engines 22(1)-(3). In a typical embodiment, the calling terminal 10 may be, for example, a mobile telephone used in an effort to reach a business listing that has been disconnected. In a typical embodiment, the call-distributor service module 14 is operable to manage call processing and voice connectivity between a system platform 24 and the network switch 12. In a typical embodiment, the system platform 24 includes the call-distributor service module 14, the call-screening service module 16, the VFN 18, the intercept service 20 and the plurality of advertising engines 22(1)-(3).

In a typical embodiment, the network switch 12 is operable to identify calls for intercept treatment. In that way, the network switch 12 may determine if a dialed number is eligible for intercept treatment. If so, the call may be routed from the calling terminal 10 to the system platform 24. Intercept treatment refers to procedures that may be enacted when a call to an individual or business cannot be completed. A call might not be able to be completed, for example, due to disconnection of the dialed number. Hereinafter, the dialed number that has been disconnected may be referenced as a disconnected listing. In such a scenario, the call may be deemed eligible for intercept treatment. Intercept treatment may include, for example, presentation of an intercept message to a caller. In a typical embodiment, as discussed in more detail below, the intercept message may include a targeted advertisement for the caller.

In a typical embodiment, the call-screening service module 16 is operable to derive additional information about the caller using the calling terminal 10, or caller characteristics, independently of the caller. In various embodiments, the caller characteristics may include raw data and/or business analytics based on the raw data. In order to obtain at least a portion of the raw data, in various embodiments, the call-screening service module 16 may utilize various existing network attributes of the call and calling number. The call-screening service module 16 may determine, for example, a caller's originating telephone number. This information includes, for example, an area code (NPA), a telephone exchange (NXX), and a line number (XXXX).

In addition, the call-screening service module 16 may be operable to develop other raw data. For example, the call-screening service module 16 may be operable to determine a station type, a date and time of the call, and location information for the caller. In a typical embodiment, determining the station type involves determining whether the calling terminal 10 is, for example, a pay phone, a hotel phone, a cellular phone or a Plain Old Telephone Service (POTS) phone serving a residence or a business. The location information may include, for example, a zip code, an address, coordinates, and other location identifiers. For example, if the calling terminal 10 is a cellular phone, Global Positioning System (GPS) data, cellular-network data, or other data may be used to determine a location of the cellular phone. As noted above, the caller characteristics may also include business analytics based on the raw data. The business analytics may include, for example, demographic data or socio-economic data based on the location information for the caller.

In a typical embodiment, the intercept service 20, via the plurality of intercept service databases, is operable to determine listing characteristics of the disconnected listing independently of the caller. For example, if the disconnected listing is a disconnected business listing, the telephone number of the disconnected business listing may be examined to derive additional information for subsequent call processing. This additional information, or the listing characteristics, may include, for example, an address and locality of a business, inactivity information, and a business category such as, for example, pharmacies or automobile-repair businesses. The inactivity information may include, for example, a length of time that has transpired since the disconnected listing was originally disconnected. The listing characteristics may further include, for example, number treatment. Number treatment refers to an audio treatment selected by the disconnected listing when the disconnect was issued. The audio treatment typically includes a recorded message played to the caller attempting to reach the disconnected business listing. The audio treatment may include, for example, a pre or post disconnect announcement, a standard disconnect announcement, or a custom advertisement.

The plurality of advertising engines 22(1)-(3) are generally responsible for delivering potential targeted advertisements to the VFN 18. In a typical embodiment, one or more of the plurality of advertising engines 22(1)-(3) may be, for example, a component of the system platform 24 or an advertising service offered by an external provider. In a typical embodiment, the potential targeted advertisements are provided based upon an advertising invitation provided by the VFN 18. The advertising invitation may include, for example, one or more of the caller characteristics, one or more of the listing characteristics, and other parameters.

The VFN 18 is typically operable to perform interactive-voice-response functionality and collaborate with other components of the system platform 24 to present a targeted advertisement to the caller. In a typical embodiment, the VFN 18 develops a call profile for the call. In a typical embodiment, the call profile contains information relating to, for example, “who is calling” and “what type of business are they trying to reach.” The call profile typically includes, for example, a combination of one or more the caller characteristics and one or more of the listing characteristics. The VFN 18 is typically operable to discover the caller characteristics from the call-screening service module 16 and the listing characteristics from the intercept service 20. In this manner, the VFN 18 may obtain the caller characteristics and the listing characteristics independently of the caller. In a typical embodiment, the VFN 18 interacts with at least one of the plurality of advertising engines 22(1)-(3) to select and obtain a targeted advertisement for presentation to the caller via the calling terminal 10.

During operation, the telephony system 100 is typically operable to examine calls that have been identified for intercept treatment. The telephony system 100 sends an advertising invitation to at least one source of recorded advertising content with, for example, the call profile associated with the call to the disconnected listing. In a typical embodiment, multiple sources of recorded advertising content may respond to the advertising invitation, via the plurality of advertising engines 22(1)-(3), by supplying a quote of a price that the source is willing to pay to present an advertisement to a caller with that call profile. In a typical embodiment, the quote of the price is part of an advertising bid. In a typical embodiment, advertising bids may be pre-set based on bidding rules established by the advertisers on the plurality of advertising engines 22(1)-(3). Thus, various sources of advertising content may bid to present an advertisement to the caller. In a typical embodiment, the plurality of advertising engines 22(1)-(3) may provide the targeted advertisements based at least in part on the call profile. The targeted advertisement may be, for example, alternative business listings that may be presented to the caller or an advertising message (e.g., a recorded advertisement).

In a typical embodiment, the telephony system 100 is operable to select which alternative listing and/or advertising message to present to the caller based on configurable criteria such as, for example, the caller characteristics, the listing characteristics, and availability of advertisers bidding for the opportunity to present the targeted advertisement to the caller. In that way, a list of alternative business listings and/or appropriate advertising messages may be derived based upon, for example, a business category of the disconnected listing, proximity to the calling terminal 10, hours of operation, socio-economic or demographic data associated with the calling terminal 10, day or time of the call, and preferences of an underlying telecommunications carrier.

Once the targeted advertisement is selected, the telephony system 100 is operable to report to the caller regarding the disconnected listing and, as part of the report, present the targeted advertisement. Thus, the telephony system 100 may report to the caller that the disconnected listing is no longer available and present a selected alternative listing and/or play a selected advertising message. Additionally, the telephony system 100 is operable to optionally connect the caller to a business listing specified in the selected alternative listing and/or the selected advertising message. In various embodiments, the telephony system 100 may generate various reports and other statistics used to measure system performance and to enable billing and collection of advertising revenue.

For example, if the caller places a call at 3:00 am from the calling terminal 10 to a 24-hour plumbing service that is no longer in business, based upon a location of the caller, the time of the call, and a business category associated with the business being called, the telephony system 100 could develop a call profile. Via the call profile, the telephony system 100 may set configurable criteria as appropriate to seek advertisements for 24-hour plumbing services near the caller's location (e.g., certain zip codes). At the plurality of advertising engines, bidding rules may be set by advertisers that allow advertisers to bid higher or lower for particular call profiles. For example, advertisers that provide 24-hour plumbing services may have pre-set advertising bids that, for example, specify a higher price for call profiles having a particular business category (i.e., 24-hour plumbing services) within a particular geographic region (e.g., specified zip codes) at specified times (e.g., between 10:00 pm and 5:00 am). The telephony system 100 may cause a targeted advertisement having a highest bid, and that meets the configurable criteria, to be presented to the calling terminal 10.

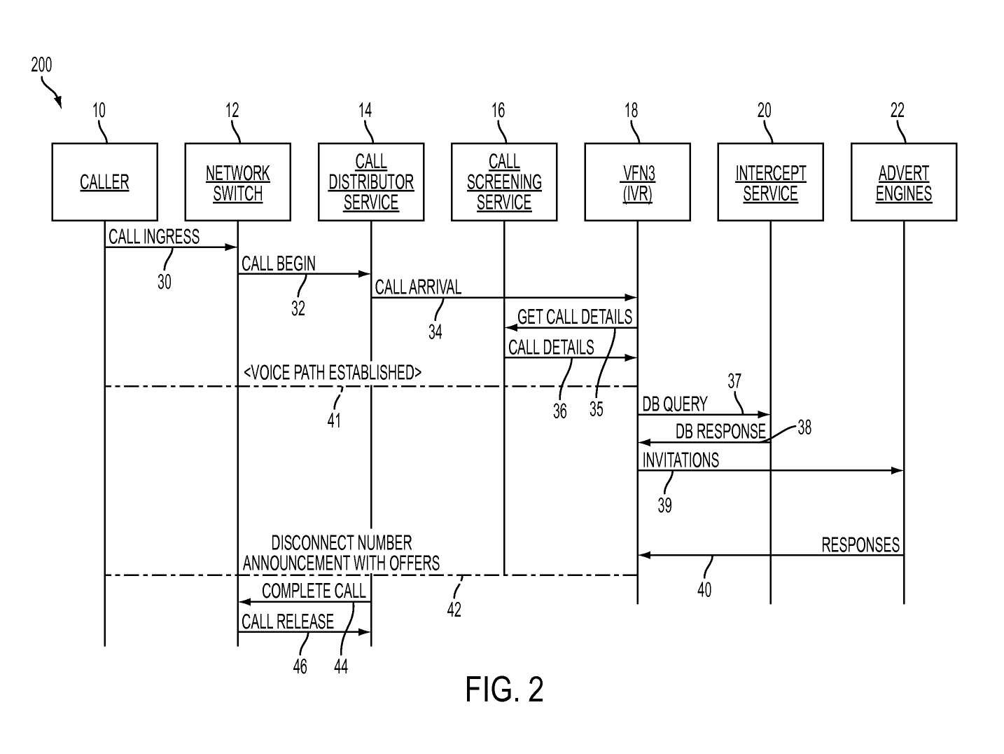

FIG. 2 is a flow diagram 200 that illustrates a call traversing the telephony system 100. In FIG. 2, an arrow between two components indicates a message from one component to another. In step 30, a call is placed by a caller via the calling terminal 10 to a telephone number that has been disconnected (i.e., a disconnected listing). In step 32, the network switch 12 determines if the disconnected listing is eligible for intercept treatment and begins the call via messaging to the call-distributor service module 14. At step 34, the call-distributor service module 14, which manages call processing and voice connectivity between the VFN 18 and the network switch 12, routes the call via messaging to the VFN 18. At step 35, the VFN 18 requests details about the call via messaging to the call-screening service module 16. At step 36, the call-screening service module 16 provides various caller characteristics associated with the calling terminal 10 via messaging to the VFN 18. At step 41, a voice path is established between the calling terminal 10 and the VFN 18.

At step 37, the VFN 18 initiates a database query via messaging to the intercept service 20. At step 38, if, for example, the disconnected listing is a disconnected business listing, the intercept service 20 provides a response to the VFN 18 containing listing characteristics for the disconnected business listing such as, for example, an address and locality of a business, a length of time that has transpired since the number was disconnected, and a business category such as, for example, pharmacies or automobile-repair businesses.

At step 39, the VFN 18 initiates an advertising invitation via messaging to at least one advertising engine 22(1)-(3) and, at step 40, assesses one or more responses received therefrom. One or more responses received by the VFN 18 from the plurality of advertising engines 22(1)-(3) may include, for example, confirmation of available advertisements, a number of advertisements available, a length of a recorded advertisement, a price that an advertiser is willing to pay, and other parameters. Finally, at step 42, the VFN 18 reports to the caller regarding the disconnected listing.

As part of reporting the disconnected listing at step 42, the VFN 18 typically interprets and plays an appropriate pre-recorded message or call dialog, along with a targeted advertisement delivered by at least one of the plurality of advertising engines 22(1)-(3), via messaging to the calling terminal 10. The targeted advertisement may be, for example, an alternative listing that can be presented to the caller and/or an advertising message (e.g., a recorded advertisement). The appropriate call dialog may include, for example, notification that the number dialed has been disconnected. The VFN 18 may also provide an opportunity for the caller to connect to a business listing associated with the alternative listing and/or advertising message. After reporting the disconnected listing to the calling terminal 10, at step 44, the call-distributor service 14 signals the network switch 12 that the call has been completed. The network switch 12 then releases the call from the call-distributor service 14 at step 46.

Although specific embodiments of the invention have been disclosed herein in some detail, this has been done solely for the purposes of describing the various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the following claims.

What is claimed is:

1. A method comprising:
developing a call profile for a call that has been identified for intercept treatment, the call comprising a call from a caller to a disconnected listing;
wherein the developing comprises accessing one or more listing characteristics for the disconnected listing independently of the caller;
selecting a targeted advertisement for the caller based at least in part on the call profile; and
reporting to the caller regarding the disconnected listing, the reporting comprising presenting the targeted advertisement to the caller.

2. The method of claim 1, wherein the developing comprises accessing one or more caller characteristics for the caller independently of the caller.

3. The method of claim 1, wherein the one or more listing characteristics comprise at least one selected from the group consisting of: a locality of a business associated with the disconnected listing, a length of time that the disconnected listing has been disconnected, number treatment, and a business category associated with the disconnected listing.

4. The method of claim 2, wherein:
the one or more caller characteristics comprise raw data, the raw data comprising at least one selected from the group consisting of: a locality of the caller, a date and time of the call, a telephone number associated with the caller, and a station type for the caller; and
the one or more caller characteristics comprise business analytics, the business analytics comprising at least one selected from the group consisting of: socioeconomic data associated with a locality of the caller and demographic data associated with a locality of the caller.

5. The method of claim 1, wherein the accessing of the one or more listing characteristics comprises initiating a database query to an intercept service database.

6. The method of claim 2, wherein the accessing of the one or more caller characteristics comprises utilizing existing network attributes of the call and a telephone number associated with the caller.

7. The method of claim 1, wherein the selecting comprises selecting the targeted advertisement based on configurable criteria.

8. The method of claim 7, wherein the configurable criteria comprises at least a portion of the listing characteristics.

9. The method of claim 7, wherein the configurable criteria comprises at least a portion of the caller characteristics.

10. The method of claim 7, wherein the configurable criteria comprises at least one selected from the group consisting of: a business category, proximity to a locality of the caller, hours of operation, socioeconomic data associated with a locality of the caller, demographic data associated with a locality of the caller, a date and time of the call, and preferences of a telecommunications carrier.

11. The method of claim 7, wherein the selecting comprises transmitting an advertising invitation to at least one source of advertising content.

12. The method of claim 11, wherein the at least one source of advertising content comprises a plurality of sources of advertising content.

13. The method of claim 11, wherein the selecting comprises receiving at least one advertising bid responsive to the transmitting, the at least one advertising bid specifying a price and a potential advertisement that meets the configurable criteria.

14. The method of claim 13, wherein
the at least one advertising bid comprises a plurality of advertising bids; and
the selecting comprises selecting the targeted advertisement from the plurality of advertising bids, the targeted advertisement being associated with an advertising bid having a highest price in the plurality of advertising bids.

15. The method of claim 14, wherein the at least one advertising bid comprises at least one selected from the group consisting of: confirmation of available advertisements, a number of advertisements available, and a length of a recorded advertisement.

16. The method of claim 15, wherein the targeted advertisement comprises at least one of an alternative business listing and an advertising message.

17. The method of claim 1, the method comprising providing an opportunity to the caller to be connected to a business associated with the targeted advertisement.

18. A system comprising:
a network switch in communication with a calling terminal;
an intercept service having access to one or more intercept service databases;
a voice feature node in communication with the network switch and the intercept service, the voice feature node operable to:
develop a call profile for a call that has been identified for intercept treatment via the network switch, the call comprising a call from a caller to a disconnected listing;
wherein said development of a call profile comprises accessing one or more listing characteristics for the disconnected listing via the intercept service;
select a targeted advertisement for the caller based at least in part on the call profile; and
report to the caller regarding the disconnected listing, the reporting comprising presenting the targeted advertisement to the caller; and
a call-distributor service module operable to manage voice connectivity between the voice feature node and the network switch.

19. The system of claim 18, wherein:
the system comprises a call-screening service module; and
wherein said development of a call profile comprises accessing one or more caller characteristics for the caller via the call-screening service module.

20. The system of claim 18, wherein the one or more listing characteristics comprise at least one selected from the group consisting of: a locality of a business associated with the disconnected listing, a length of time that the disconnected listing has been disconnected, number treatment, and a business category associated with the disconnected listing.

21. The system of claim 19, wherein:
the one or more caller characteristics comprise raw data, the raw data comprising at least one selected from the group consisting of: a locality of the caller, a date and time of the call, a telephone number associated with the caller, and a station type for the caller; and
the one or more caller characteristics comprise business analytics, the business analytics comprising at least one selected from the group consisting of: socioeconomic data associated with a locality of the caller and demographic data associated with a locality of the caller.

22. The system of claim 18, wherein the access of the one or more listing characteristics comprises initiating a database query to at least one of the one or more intercept service databases.

23. The system of claim 19, wherein the access of the one or more caller characteristics comprises utilizing existing network attributes of the call and a telephone number associated with the caller.

24. The system of claim 18, wherein the selection comprises selection of the targeted advertisement based on configurable criteria.

25. The system of claim 24, wherein the configurable criteria comprises at least a portion of the listing characteristics.

26. The system of claim 24, wherein the configurable criteria comprises at least a portion of the caller characteristics.

27. The system of claim 24, wherein the configurable criteria comprises at least one selected from the group consisting of: a business category, proximity to a locality of the caller, hours of operation, socioeconomic data associated with a locality of the caller, demographic data associated with a locality of the caller, a date and time of the call, and preferences of a telecommunications carrier.

28. The system of claim 24, wherein:
the system comprises at least one advertising engine, each of the at least one advertising engine comprising a source of advertising content; and
the selection comprises transmission of an advertising invitation to at least one of the at least one advertising engine.

29. The system of claim 28, wherein the at least one of the at least one advertising engine comprises a plurality of advertising engines.

30. The system of claim 28, wherein the selection comprises receipt of at least one advertising bid responsive to the transmission, the at least one advertising bid specifying a price and a potential advertisement that meets the configurable criteria.

31. The system of claim 30, wherein:
the at least one advertising bid comprises a plurality of advertising bids; and
the selection comprises selection of the targeted advertisement from the plurality of advertising bids, the targeted advertisement being associated with an advertising bid having a highest price in the plurality of advertising bids.

32. The system of claim 31, wherein the at least one advertising bid comprises at least one selected from the group consisting of: confirmation of available advertisements, a number of advertisements available, and a length of a recorded advertisement.

33. The method of claim 32, wherein the targeted advertisement comprises at least one of an alternative business listing and an advertising message.

34. The method of claim 1, the method comprising providing an opportunity to the caller to be connected to a business associated with the targeted advertisement.
